(19) United States
(12) Patent Application Publication
(10) Pub. No.: US 2013/0264729 A1
(43) Pub. Date: Oct. 10, 2013

(54) Method for Manufacturing Mold Assembly of Multi-Functional Light Guide Plate and its Application

(71) Applicants: Tzu-Chu Huang, Kaohsiung City (TW); Shih-Yun Huang, Kaohsiung City (TW); Ching-Cheng Hsu, Kaohsiung City (TW); Chun-Yu Fang, Kaohsiung City (TW)

(72) Inventors: Tzu-Chu Huang, Kaohsiung City (TW); Shih-Yun Huang, Kaohsiung City (TW); Ching-Cheng Hsu, Kaohsiung City (TW); Chun-Yu Fang, Kaohsiung City (TW)

(21) Appl. No.: 13/584,889

(22) Filed: Aug. 14, 2012

(30) Foreign Application Priority Data
Apr. 5, 2012 (TW) 101112015

(51) Int. Cl. G02B 6/10

(52) U.S. Cl. 264/1.27

(57) ABSTRACT

The present invention provides a method for manufacturing a mold assembly of multi-functional light guide plate, which firstly forming a first photoresist layer with a light scattering pattern and forming a second photoresist layer with a light scattering pattern. After the processes of forming a conductive layer, electroforming a conductive mold, and separating a male mold from the conductive mold, a first male mold has a pattern corresponding to the light guiding pattern and a second male mold also has a pattern corresponding to the light scattering pattern. Besides, the present invention also provides a method for manufacturing a multi-functional light guide plate by using two of the mold assembly of the present invention. Because the produced multi-functional light guide plate has the advantages of high transmittancy, the multiple optical sheets in conventional display device can be replaced by the multi-functional light guide plate of the present invention.

### BACKGROUND OF THE INVENTION

1. Field of the Invention

The present invention relates to a method for manufacturing a mold assembly of a multi-functional light guide plate. In addition, the present invention also relates to a method for manufacturing a multi-functional light guide plate, especially to a multi-functional light guide plate having light guiding function and light scattering function.

2. Description of the Prior Arts

Currently, most electronic products are designed in a tendency towards being lightweight, thin and small. For example, marketing requirements of weight-reduction, thinning, high brightness and high light uniformity are considerable for thin-film liquid crystal display devices. In order to improve the competitiveness in the electronics field, companies are devoted to the design of various innovative backlight modules and their light guide plates, which are the most important developments and issues in the related field.

With regards to conventional methods of producing a light guide plate, the light guide plate suitable for small-size display devices is obtained by etching the stainless plate first followed by disposing the etched stainless plate on the injection molding equipment to form a small-size light guide plate. However, the injection molding equipment cannot bear the load of an overweight stainless plate, resulting in failure of the etching process. For backlight modules using a light emitting diode as the backlight source, the display device with an increased brightness, fewer lamps and a lowered manufacture cost is also in an urgent need in the present market. How to produce a light guide plate meeting the afore-mentioned requirements has faced quite a predicament.

When the size of backlight source is minimized by using the light emitting diode and when the large-size display device is thinner than before, the light guide plate is also required to decrease its thickness to meet the marketing requirements. Furthermore, if the luminance of the light guide plate can be improved, the expensive optical sheets such as prism sheets, scattering sheets, brightness-improving sheets, and reflective sheets are not required anymore, and thus the manufacturing cost of the display device can be reduced by using a multi-functional light guide plate.

TW patent No. I305278 discloses a method for manufacturing a diffraction grating element mold and a grating element. The method incorporates a holography interference lithography technique and an electroforming technique to manufacture a metallic mold core. The metallic mold core is applied to replica molding of micro hot-embossing and flexible printing to duplicate the diffraction grating element. In this patent, the laser beam is split into two planer waves having same light intensity by using a beam splitter. Two planer waves respectively pass through a reflective mirror and intersect onto the interference plane, whereby an interference effect is occurred on the interference plane and forms a diffracted grating pattern.

However, the method is only effective on manufacturing one diffracted grating pattern with an identical width, but cannot form different optical patterns (e.g. light guiding pattern and light scattering pattern) onto different substrates by one single optical system. Therefore, the conventional optical sheets including scattering sheets, brightness-improving sheets and reflective sheets in a display device still cannot be omitted, and fail to improve the brightness, luminance or light uniformity of the display device.

Therefore, in order to meet the requirements of weight-reduction, thinning, high brightness, high luminance and high light uniformity, there is a need to develop a method for manufacturing a multi-functional light guide plate having both light guiding function and light scattering function.

### SUMMARY OF THE INVENTION

The primary objective of the present invention is to provide a multi-functional light guide plate with light guiding and light scattering functions. The multi-functional light guide plate manufactured by using a mold assembly in accordance with the present invention can replace the conventional optical sheets such as scattering sheets, brightness-improving sheets and/or reflective sheets, and provide a display device comprised of the same with high brightness, high luminance and high light uniformity so as to meet the marketing requirements of lower manufacturing cost, thinning, and weight-reduction.

To achieve the aforementioned objectives, the present invention provides a method for manufacturing a mold assembly of a multi-functional light guide plate, comprising the steps of:

(S1) forming a first photoresist layer on a first substrate and forming a second photoresist layer on a second substrate;

(S2) etching the first photoresist layer by using a first laser beam to form a light guiding pattern in the first photoresist layer and etching the second photoresist layer by using a second laser beam to form a light scattering pattern in the second photoresist layer,

wherein the light guiding pattern comprises multiple first microstructures formed in the first photoresist layer, and each first microstructure has multiple first grooves extending along a first direction and parallel to each other, and

the light scattering pattern comprises at least one second microstructure and at least one third microstructure formed in the second photoresist layer, each second microstructure has multiple second grooves extending along a second direction and parallel to each other, each third microstructure has multiple third grooves extending along a third direction and parallel to each other, and the third direction is arranged at an angle larger than 0° and smaller than 180° to the second direction;

(S3) forming a first conductive film on the first photoresist layer having the light guiding pattern to obtain a first conductive mold and forming a second conductive film on the second photoresist layer having the light scattering pattern to obtain a second conductive mold; and

(S4) electroforming a first male mold on the first conductive mold and electroforming a second male mold on the second conductive mold, so as to obtain the mold assembly comprising the first male mold and the second male mold,

wherein the first male mold has a pattern corresponding to the light guiding pattern of the first photoresist layer, the pattern comprises multiple fourth microstructures formed on the first male mold, and the fourth microstructures are complementary to the corresponding first microstructures of the light guiding pattern, and

the second male mold has a pattern corresponding to the light scattering pattern of the second photoresist layer, the pattern comprises at least one fifth microstructures and at least one sixth microstructures formed on the second male mold, the at least one fifth microstructure is complementary to the at least one corresponding second microstructure of the light scattering pattern, and the at least one sixth microstructure is complementary to the at least one corresponding third microstructure of the light scattering pattern.

Accordingly, the method for manufacturing a mold assembly of a multi-functional light guide plate in accordance with the present invention etches a light guiding pattern in the first photoresist layer by using the first laser beam and a light scattering pattern in the second photoresist layer by using the second laser beam. Subsequently, a first conductive mold with the light guiding pattern and a second conductive mold with the light scattering pattern are further electroformed to respectively produce a first male mold having the fourth microstructures and a second male mold having the at least one fifth microstructure and at least one sixth microstructure, and thereby the first male mold with a pattern corresponding to the light guiding pattern in the first photoresist layer and the second male mold with a pattern corresponding to the light scattering pattern in the second photoresist layer are produced.

The term “being complementary to” as used hereby refers two individual components, patterns or structures can be mutually matched with each other when their surfaces are closed by. That is, if there is a recess in one individual component, pattern or structure, there is also a bulge on the corresponding surface of another individual component pattern or structure and corresponding to the recess. Or, if there is a bulge on one individual component, pattern or structure, there is also a recess in another individual component pattern or structure and corresponding to the bulge. If there is a planar surface on one individual component, pattern or structure, there is also a planar surface on another individual component pattern or structure.

Preferably, the first substrate and/or the second substrate are glass substrates, metal substrates, or plastic substrates.

The step (S2) of the method in accordance with the present invention comprises etching the first photoresist layer and the second photoresist layer by dot-matrix laser photolithographic technique.

Preferably, the step (S2) of the method in accordance with the present invention further comprises the steps of: providing a focused laser beam; shaping the focused laser beam by passing the focused laser beam through a hole; interfering the focused laser beam with an adjustable rotating grating to obtain multiple interfered laser beams with various predetermined energies; and focusing two interfered laser beams with a second highest energy to form the first laser beam or the second laser beam.

Preferably, the hole has a shape in rectangle, circle, or triangle, but not limited to thereof. Preferably, the hole has a diameter ranging from 10 micrometers to 100 micrometers, so that the obtained first laser beam and the obtained second laser beam have resolutions ranging from 254 dots per inch (dpi) to 2540 dpi.

Said “adjustable rotating grating” refers to a rotating grating with slit intervals and movement that are able to be changed as required to produce different interfered effects and to form two different desired patterns on two different photoresist layers. For example, if the slits of the adjustable rotating grating are spaced with a constant interval (i.e., an adjustable rotating grating with a constant slit density) and the adjustable rotating grating is fixed at a constant angle in front of a focused laser beam, a first laser beam with parallel etching route is obtained. If the slits of the adjustable rotating grating are spaced with multiple different intervals (i.e., an adjustable rotating grating with various slit densities) and the adjustable rotating grating is rotated at a speed ranging from 90°/sec to 180°/sec at a fixed position in front of the focused laser beam, a second laser beam with non-parallel etching routes is obtained. Thus, the light scattering pattern having at least one second microstructure and at least one third microstructure that arranged at an angle is formed on the second photoresist layer.

Therefore, the adjustable rotating grating of the present invention can provide different interfered effects depending on its slit density and movement, and thereby controlling the respective etching routes of the first laser beam on the first photoresist layer and the second laser beam on the second photoresist layer in order to form a light guiding pattern in the first photoresist layer and a light scattering pattern in the second photoresist layer.

According to the method for manufacturing a mold assembly of a multi-functional light guide plate, each first microstructure has multiple first grooves. The first grooves have the same width and parallel to each other. Thus, each fourth microstructure also has multiple fourth grooves corresponding to the first grooves, and the fourth grooves also have the same width and parallel to each other. Preferably, the area rate of the fourth microstructures over the first male mold ranges from 10% to 80%, which gradually increasing from a side (10%) to the other side (80%) of the first male mold. More preferably, the first grooves have the same depth, and the fourth grooves corresponding to the first grooves also have the same depth.

Preferably, each second microstructure has multiple second grooves, and the second grooves have various widths and parallel to each other. Preferably, each third microstructure has multiple third grooves, and the third grooves have various widths and parallel to each other.

In one embodiment of the light scattering pattern in accordance with the present invention, the angle between the second direction of the second grooves and the third direction of the third grooves ranges from 15° to 90°. More preferably, the second grooves of each second microstructure have various depths; and the third grooves of each third microstructure also have various depths.

In another embodiment of the present invention, each second microstructure has multiple first sub-microstructures and multiple second sub-microstructures distributed at a region of the second microstructure and formed in the second photoresist layer. Each first sub-microstructure has multiple seventh grooves extending along a seventh direction and parallel to each other, and each second sub-microstructure has multiple eighth grooves extending along a eighth direction and parallel to each other. Preferably, the eighth direction is arranged at an angle ranging from 15° to 90° to the seventh direction. The seventh grooves of the first sub-microstructures have various widths, and the eighth grooves of the second sub-microstructures also have various widths. More preferably, the seventh grooves of each first sub-microstructure have various depths, and the eighth grooves of each second sub-microstructure also have various depths.

The cross-sectional shape of the first grooves, the second grooves, and the third grooves may be changed depending on different requirements, for example, V-shaped, U-shaped, or arc-shaped. Preferably, the first grooves, the second grooves, and the third grooves have widths ranging from 0.3 micrometers to 0.9 micrometers and depths ranging from 0.2 micrometers to 0.5 micrometers. The depths of the first grooves, the second grooves, and the third grooves more preferably ranges from 0.3 micrometers to 0.5 micrometers, and further more preferably ranges from 0.3 micrometers to 0.4 micrometers.

Preferably, the fourth grooves, the fifth grooves, and the sixth grooves also have widths ranging from 0.3 micrometers to 0.9 micrometers and depths ranging from 0.2 micrometers to 0.5 micrometers. The depths of the fourth grooves, the fifth grooves, and the sixth grooves more preferably ranges from 0.3 micrometers to 0.5 micrometers, and further more preferably ranges from 0.3 micrometers to 0.4 micrometers.

The step (S3) of the method in accordance with the present invention comprises forming the first film and the second film by silver-mirror process, evaporation process or sputtering process in order to obtain a first conductive mold and a second conductive mold.

The step (S4) of the method in accordance with the present invention comprises the steps of: immersing the first conductive mold and the second conductive mold in a Ni—Co alloy electroforming bath to form a first Ni—Co electroform product on the first conductive mold and a second Ni—Co electroform product on the second conductive mold respectively; separating the first Ni—Co electroform product from the first conductive mold so as to obtain the first male mold and separating the second Ni—Co electroform product from the second conductive mold so as to obtain the second male mold. Herein, the separated first and the second Ni—Co electroform product is respectively the first and the second male mold.

A step (S5′) is further performed after the step (S4). The step (S5′) of the method in accordance with the present invention comprises electroforming a first female mold on the first male mold. The first female mold has a pattern corresponding to the pattern of the first male mold, and the pattern of the first female mold comprises multiple ninth microstructures formed in the first female mold, and the ninth microstructures are complementary to the corresponding fourth microstructures. Therefore, the pattern of the first female mold is same with the light guiding pattern of the first photoresist layer. The mold assembly used for forming a multi-functional light guide plate in accordance with the present invention further comprises a first female mold.

The ninth microstructure has multiple ninth grooves extending along a ninth direction and parallel to each other, and the ninth grooves have the same width ranging from 0.3 micrometers to 0.9 micrometers and the same depth ranging from 0.2 micrometers to 0.5 micrometers.

Besides, a step (S5″) can be further performed after the step (S4) in the aforementioned method. The step (S5″) of the method in accordance with the present invention comprises the step of electroforming a second female mold on the second male mold. The second female mold has a pattern corresponding to the pattern of the second male mold, and the pattern of the second female mold comprises at least one tenth microstructure and at least one eleventh microstructure formed in the second female mold, and the at least one tenth microstructure is complementary to the at least one corresponding fifth microstructure and the at least one eleventh microstructure is complementary to the at least one corresponding sixth microstructure of the first male mold. Therefore, the pattern of the second female mold is same with the light scattering pattern of the second photoresist layer. Accordingly, the mold assembly used for forming a multi-functional light guide plate in accordance with the present invention further comprises a second female mold.

Each tenth microstructure has multiple tenth grooves extending along a tenth direction, and each eleventh microstructure has multiple eleventh grooves extending along an eleventh direction. The tenth grooves of each tenth microstructure have widths ranging from 0.3 micrometers to 0.9 micrometers and depths ranging from 0.2 micrometers to 0.5 micrometers. The eleventh grooves of each eleventh microstructure also have widths ranging from 0.3 micrometers to 0.9 micrometers and depths ranging from 0.2 micrometers to 0.5 micrometers. The tenth grooves are parallel to each other, and the eleventh grooves are also parallel to each other. Preferably, the angle between the tenth direction and the eleventh direction ranges from 15° to 90°.

In the method for manufacturing a mold assembly of a multi-functional light guide plate, both the aforementioned step (S5′) and step (S5″) can be performed in the method, or one of the steps can be chosen to be performed depending on different requirements. Accordingly, the method in accordance with the present invention can produce various molds with different microstructures such as first male mold, second male mold, first female mold and/or second female mold.

To achieve the aforementioned objectives, the present invention also provides a method for manufacturing a multi-functional light guide plate, comprising the steps of: providing a first male mold and a second male mold manufactured by the aforementioned method; providing a raw material; and molding the raw material by using the first male mold and the second male mold by injection molding, imprint molding, or calendaring to obtain the multi-functional light guide plate; wherein the multi-functional light guide plate has a light guiding pattern formed in a surface of the multi-functional light guide plate and a light scattering pattern formed in the opposite surface of the multi-functional light guide plate, and the multi-functional light guide plate has a light transmittance ranging from 88% to 93%.

To achieve the aforementioned objectives, the present invention also provides a method for manufacturing a multi-functional light guide plate, comprising the steps of: providing a first male mold and a second female mold manufactured by the aforementioned method; providing a raw material; and molding the raw material by using the first male mold and the second female mold by injection molding, imprint molding, or calendaring to obtain the multi-functional light guide plate; wherein the multi-functional light guide plate has a light guiding pattern formed in a surface of the multi-functional light guide plate and a light scattering pattern formed in the opposite surface of the multi-functional light guide plate, and the multi-functional light guide plate has a light transmittance ranging from 88% to 93%.

To achieve the aforementioned objectives, the present invention also provides a method for manufacturing a multi-functional light guide plate, comprising the steps of: providing a first female mold and a second male mold manufactured by the aforementioned method; providing a raw material; and molding the raw material by using the first female mold and the second male mold by injection molding, imprint molding, or calendaring to obtain the multi-functional light guide plate; wherein the multi-functional light guide plate has a light guiding pattern formed in a surface of the multi-functional light guide plate and a light scattering pattern formed in the opposite surface of the multi-functional light guide plate, and the multi-functional light guide plate has a light transmittance ranging from 88% to 93%.

To achieve the aforementioned objectives, the present invention also provides a method for manufacturing a multi-functional light guide plate, comprising the steps of: providing a first female mold and a second female mold manufactured by the aforementioned method; providing a raw material; and molding the raw material by using the first female mold and the second female mold by injection molding, imprint molding, or calendaring to obtain the multi-functional light guide plate; wherein the multi-functional light guide plate has a light guiding pattern formed in a surface of the multi-functional light guide plate and a light scattering pattern formed in the opposite surface of the multi-functional light guide plate, and the multi-functional light guide plate has a light transmittance ranging from 88% to 93%.

Preferably, the raw material used for manufacturing the multi-functional light guide plate is poly (methyl methacrylate) (PMMA), polyethylene terephthalate (PET), or polycarbonate (PC).

By using the first female mold or the first female mold, a light guiding pattern can be formed on or formed in one surface of the multi-functional light guide plate; and further by using the second female mold or the second male mold, a light scattering pattern can be formed on or formed in the other surface of the multi-functional light guide plate. Thus, a multi-functional light guide plate with both light guiding function and light scattering function can be produced in accordance with the present invention.

Because the method for manufacturing the mold assembly of the multi-functional light guide plate in accordance with the present invention focuses two interfered laser beams with the second highest energy to etch the first photoresist layer and the second photoresist layer, the depths of the aforementioned grooves can be maintained in the preferable range and ensure that the microstructures are merely formed in the shallow surface of the first photoresist layer and the second photoresist layer.

Thus, the mold assembly in accordance with the present invention can be used for forming a multi-functional light guide plate with high luminance, high brightness and high uniformity requirements.

In conclusion, the present invention produces a mold assembly with light guiding pattern and/or light scattering pattern by performing dot-matrix laser photolithographic process, electroforming process and separation process. In addition, the present invention can selectively combine a first male or a female mold with a second male or a female mold to produce a multi-functional light guide plate having light guiding and scattering functions and with high light transmittance.

Other objectives, advantages and novel features of the invention will become more apparent from the following detailed description when taken in conjunction with the accompanying drawings.

### BRIEF DESCRIPTION OF THE DRAWINGS

FIG. 1A is a block diagram of a method for manufacturing a first male mold and a second male mold in accordance with the present invention;

FIG. 1B is a schematic diagram of a method for manufacturing a first male mold and a second male mold in accordance with the present invention;

FIG. 2 is a diagram of optical system of the dot-matrix laser photolithographic in accordance with the present invention;

FIG. 3 is a side sectional view of a first male mold in accordance with the present invention;

FIG. 4 is a side sectional view of a second male mold of one embodiment in accordance with the present invention;

FIG. 5 is a side sectional view of a second male mold of another embodiment in accordance with the present invention.

FIG. 6A is a block diagram of a method for manufacturing a first female mold in accordance with the present invention;

FIG. 6B is a schematic diagram of a method for manufacturing a first female mold in accordance with the present invention;

FIG. 7A is a block diagram of a method for manufacturing a second female mold in accordance with the present invention

FIG. 7B is a schematic diagram of a method for manufacturing a second female mold in accordance with the present invention;

FIG. 8 is a combination diagram of a first male mold and the second female mold in accordance with the present invention;

FIG. 9 is a combination diagram of a first male mold and the second male mold in accordance with the present invention;

FIG. 10 is a combination diagram of a first female mold and the second male mold in accordance with the present invention;

FIG. 11 is a combination diagram of a first female mold and the second female mold in accordance with the present invention;

FIG. 12 is a scanning electron microscopy (SEM) image of one surface of the multi-functional light guide plate having a light guiding pattern in accordance with the present invention; and

FIG. 13 is an SEM image of the other surface of the multi-functional light guide plate having a light scattering pattern in accordance with the present invention.

### DETAILED DESCRIPTION OF THE PREFERRED EMBODIMENTS

Hereinafter, one skilled in the arts can easily realize the advantages and effects of a method for manufacturing a mold assembly of a multi-functional light guide plate and a method for manufacturing multi-functional light guide plate in accordance with the present invention from the following examples. Therefore, it should be understood that the descriptions proposed herein are just preferable examples only for the purpose of illustrations, not intended to limit the scope of the invention. Various modifications and variations could be made in order to practice or apply the present invention without departing from the spirit and scope of the invention.

### Example 1

### Manufacturing the Mold Assembly Comprising a First Male Mold and a Second Male Mold

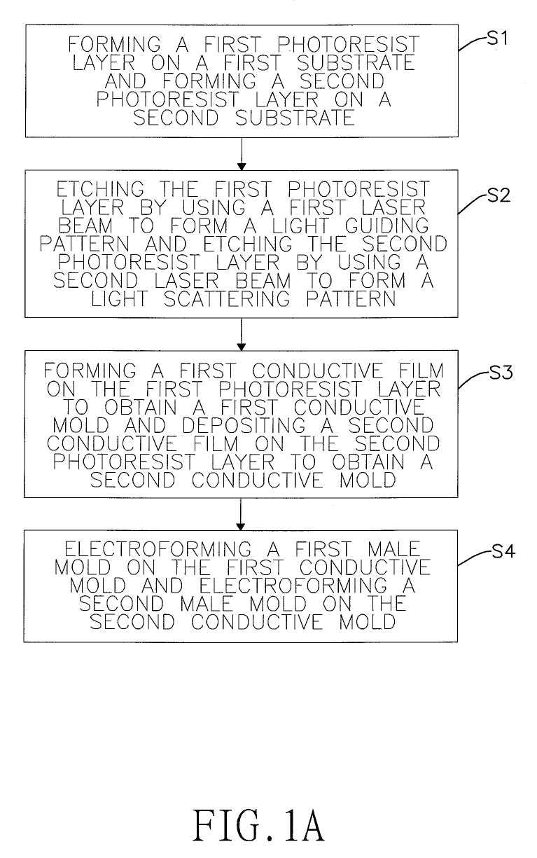

With reference to FIGS. 1A and 1B, the method for manufacturing the mold assembly of multi-functional light guide plate was performed by the following process:

First, two independent substrates were provided. One was used for forming a light guiding plate namely first substrate 110, and the other one was used for forming a light scattering plate namely second substrate 210. In the step (S1), a first photoresist layer 111 was formed on the first substrate 110, and a second photoresist layer 211 was formed on the second substrate 210. In the present example, the first substrate 110 and the second substrate 210 were glass substrates. The first photoresist layer 111 and the second photoresist layer 211 had thickness about 1.5 micrometers, respectively.

In the step (S2), a first laser beam and a second laser beam were respectively used for etching the first photoresist layer 111 and the second photoresist layer 211 by dot-matrix laser photolithographic technique, so as to form a light guiding pattern 121 in the first photoresist layer 111 and a light scattering pattern 221 in the second photoresist layer 211.

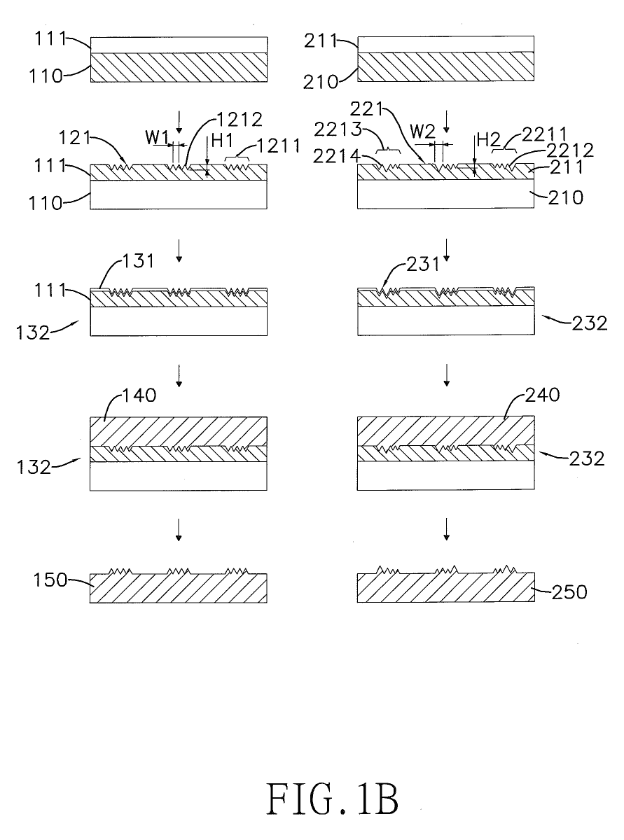

With further reference to FIG. 2, said dot-matrix laser photolithographic technique was performed by the following process. First, a laser source 310 having a solid laser diode with a wavelength of 365 nm and power of 40 W was provided. Then, the laser source 310 was sequentially passed through a convex lens 321 and a concave lens 322 to form a focused laser beam. After that, the focused laser beam was passed through a hole 330 with a diameter of 50 micrometers to produce a laser beam with a resolution of 508 dpi. Wherein, the hole 330 could be shaped into various shapes depending on different requirements in order to produce a laser beam with corresponding shape, for example rectangle, circle, or triangle, but not limited to thereof.

Subsequently, the shaped laser beam was passed through an adjustable rotating grating, and then producing multiple interfered laser beams with decreasing light energies, that were n=0, ±1, ±2 . . . of interfered laser beams. All of the interfered laser beams were blocked except for two interfered laser beams with the second highest energy (i.e. the interfered laser beams with n=±1). Then, two interfered laser beams with the second highest energy were further focused by passing two interfered laser beams through another convex lens 360 to form the first laser beam for etching the first photoresist layer 111 and the second laser beam for etching the second photoresist layer 211.

With reference to FIGS. 1B and 2, in order to etch the first photoresist layer 111 and form a light guiding pattern 121 therein, the adjustable rotating grating 340 comprised multiple slits 341 spaced with a constant interval in between, and the adjustable rotating grating 340 was fixed in front of the focused laser beam and perpendicular to the incident direction of the focused laser beam, that obtain the first laser beam with fixed etching route. In order to etch the second photoresist layer 211 and form a light scattering pattern 221 therein, the adjustable rotating grating 340 comprised multiple slits 341 spaced with different intervals, and the adjustable rotating grating 340 was rotated with 180°/sec at a fixed position in front of the focused laser beam, that obtain the second laser beam with various etching route.

Accordingly, the formed light guiding pattern 121 had multiple first microstructures 1211, each first microstructure 1211 had multiple first grooves 1212. The first grooves 1212 were extended along a first direction and parallel to each other. The first grooves 1212 had the same width W1 of 546 nm and the same depth H1 ranging from 300 nm to 500 nm.

The light scattering pattern 221 had at least one second microstructure 2211 and at least one third microstructure 2213 formed in the second photoresist layer 211. Each second microstructure 2211 had multiple second grooves 2212. The second grooves 2212 were extended along a second direction and parallel to each other. Each third microstructure 2213 has multiple third grooves 2214. The third grooves 2214 were extended along a third direction and parallel to each other. Wherein, the third direction is arranged at an angle ranging from 15° to 90° to the second direction (not shown in FIG. 1B). The second grooves 2212 of the same second microstructure 2211 had various widths W2 ranging from 300 nm to 900 nm and various depths H2 ranging from 300 nm to 500 nm. The third grooves 2214 of the same third microstructure 2213 also had various widths W3 ranging from 300 nm to 900 nm and various depths H3 ranging from 300 nm to 500 nm.

Accordingly, the present invention controlled the etching route of the first laser beam and the second laser beam by adjusting the slit intervals and movement of the adjustable rotating grating, and thereby forming different optical patterns with different optical characteristics.

In the step (S3), a 200 nm-thick first conductive film 131 was formed on the first photoresist layer 111 with the light guiding pattern 121, so as to obtain a first conductive mold 132 with conductivity. Similarly, 200 nm-thick second conductive film 231 was also formed on the second photoresist layer 211 with the light scattering pattern 221, so as to obtain a second conductive mold 232 with conductivity.

In the step (S4), the first conductive mold 132 and the second conductive mold 232 were immersed in a Ni—Co alloy electroforming bath to form a first Ni—Co electroform product 140 on the first conductive mold 132 and a second Ni—Co electroform product 240 on the second conductive mold 232, respectively. After that, the first Ni—Co electroform product 140 was separated from the first conductive mold 132 to obtain the first male mold 150, and the second Ni—Co electroform product 240 was also separated from the second conductive mold 232 to obtain the second male mold 250.

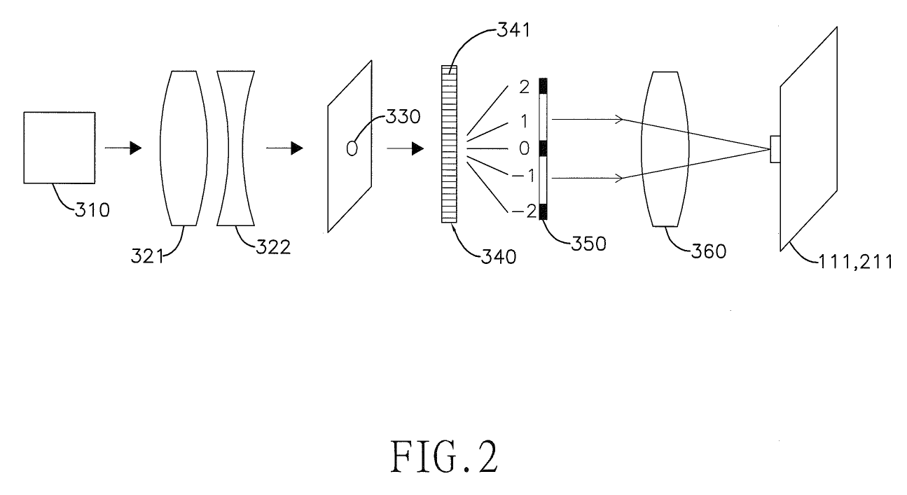

In one preferable embodiment of the present invention, the first male mold 150 had a pattern corresponding to the light guiding pattern 121 of the first photoresist layer 111, as shown in FIGS. 1B and 3. The first male mold 150 had multiple fourth microstructures 1501 formed on the surface of the first male mold 150, and the fourth microstructures 1501 were complementary to the corresponding first microstructures 1211. Wherein, the fourth microstructure 1501 comprised multiple fourth grooves 1502. The fourth grooves 1502 were extended along the fourth direction D4 and parallel to each other. And the fourth grooves 1502 had the same width and the same depth. The fourth microstructures 1501 disposed near one side of the first male mold 150 had an area rate of 80% and gradually decreasing to 10% at the other side relative the area of the first male mold 150.

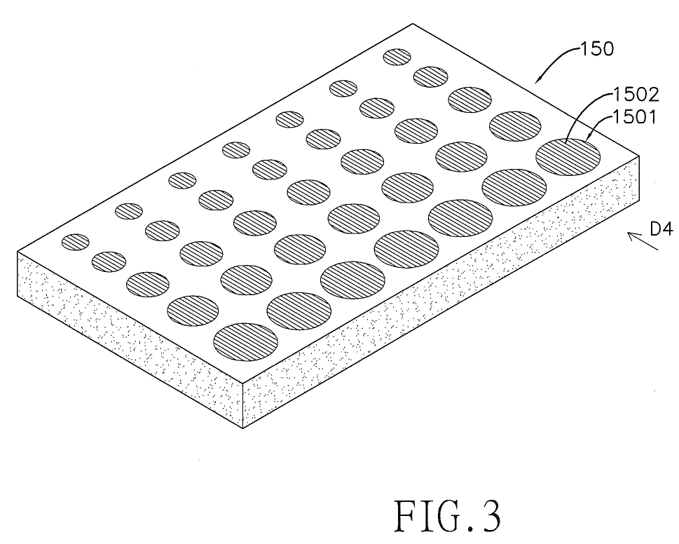

Besides, the second male mold 250 also had a pattern corresponding to the light scattering pattern 221 of the second photoresist layer 211, as shown in FIGS. 1B and 4. The second male mold 250 comprised at least one fifth microstructure 2501 and at least one sixth microstructure 2503 formed on the second male mold 250. The at least one fifth microstructure 2501 was complementary to the at least one corresponding second microstructure 2211, and the at least one sixth microstructure 2503 was complementary to the at least one corresponding third microstructure 2213. Wherein, each fifth microstructure 2501 had multiple fifth grooves 2502. The fifth grooves 2502 were extended along a fifth direction D5 and parallel to each other. Each sixth microstructures 2503 also had multiple sixth grooves 2504. The sixth grooves 2504 were extended along a sixth direction D6 and parallel to each other. The fifth grooves 2502 had various widths and various depths, and the sixth grooves 2504 had various widths and various depths likewise. In addition, the sixth direction was arranged at an angle ranging from 15° to 90° to the fifth direction. A region of the at least one fifth microstructure 2501 and the at least one sixth microstructure 2503 had an area rate relative the area of the second male mold 250. The at least one fifth microstructure 2501 and the at least one sixth microstructure 2503 disposed near one side of the second male mold 250 had an area rate of 80% and gradually decreasing to 10% at the other side relative the area of the second male mold 250.

In another preferable embodiment, the second male mold may have another pattern corresponding to another light scattering pattern of the second photoresist layer. In the step (S2), a second microstructure comprised in the scattering pattern was composed of multiple first sub-microstructures and multiple second sub-microstructures distributed at a region of the second microstructure and formed in the second photoresist layer. Each first sub-microstructures comprised multiple seventh grooves extending along a seventh direction and parallel to each other, and each second sub-microstructure has multiple eighth grooves extending along an eighth direction and parallel to each other. Here, the seventh grooves had various widths and various depths, and the eighth grooves also had various widths and various depths.

Furthermore, the third microstructure also had multiple sub-microstructures distributed at the region of the third microstructures as same as the second microstructure.

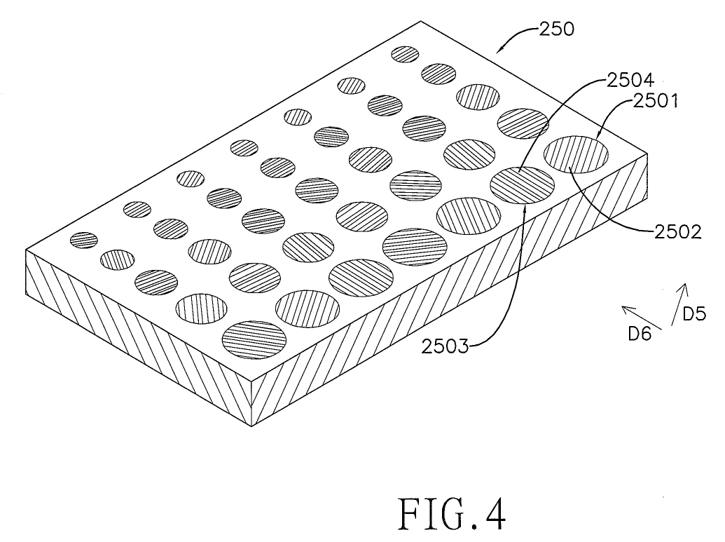

After the steps (S3) and (S4), the second male mold also had a pattern corresponding to the aforementioned light scattering pattern in another preferable embodiment. With reference to FIG. 5, the second male mold 520 had multiple fifth microstructures 521 comprising multiple third sub-microstructures 522 and fourth sub-microstructures 523. The third sub-microstructures 522 and fourth sub-microstructures 523 were distributed at a region of the fifth microstructures 521 and formed on the second male mold 520. Each third sub-microstructure 522 was complementary to the corresponding first sub-microstructure, and each fourth sub-microstructure 523 was complementary to the corresponding second sub-microstructure.

With reference to FIG. 5, the third sub-microstructure 522 had multiple grooves 5221 extending along the same direction and parallel to each other, and the grooves 5221 of the third sub-microstructure 522 had various widths. The fourth sub-microstructure 523 also has the similar grooves with the third sub-microstructure 522. The grooves 5221 of the third sub-microstructure 522 formed extending along the same direction and including an angle from 15° to 90° with the direction of the grooves of the fourth sub-microstructure 523.

Accordingly, the method for manufacturing a mold assembly of a multi-functional light guide plate in accordance with the present invention produced a first male mold with light guiding pattern and a second male mold with the light scattering pattern.

### Example 2

### Manufacturing a First Female Mold

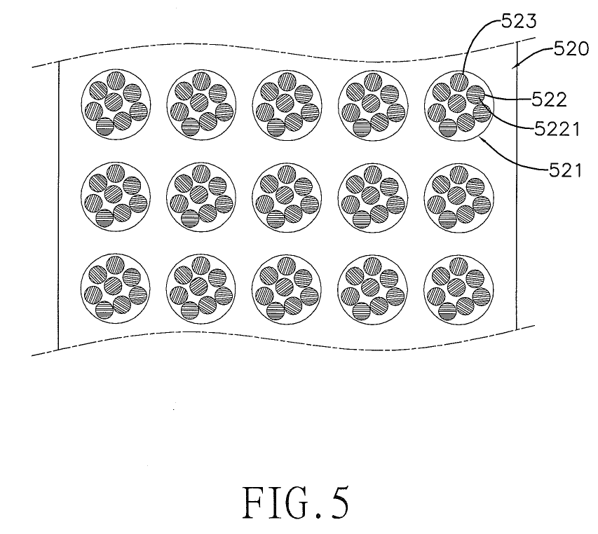

With reference to FIGS. 6A and 6B, the method for manufacturing a first female mold was implemented as described in the method of the Example 1. In the present embodiment, a first photoresist layer 611 was formed onto the first substrate 610 in the step (S1); the first photoresist layer 611 was etched as the Example 1 and formed with a light guiding pattern 621 in the step (S2); a first conductive layer 631 was further formed on the first photoresist layer 611 with the light guiding pattern 621 so as to obtain a first conductive mold 632 in the step (S3); the first conductive mold 631 was electroformed and form a Ni—Co electroform product 640 on the first conductive mold 631, and the Ni—Co electroform product 640 separated from the first conductive mold 631 was the first male mold 650.

After that, the first male mold 650 was used as a conductive mold. The first male mold 650 was then immersed in a Ni—Co alloy electroforming bath to form a first female mold 660 on the first male mold 650 in the step (S5′). Thus, a first female mold 660 with a pattern corresponding to the pattern of the first male mold 650 was obtained.

Here, the first female mold 660 had multiple ninth microstructures 661 formed in the surface of the first female mold 660, and each ninth microstructure 661 was complementary to the corresponding fourth microstructure of the first male mold 650. The fourth microstructures of the first male mold 650 were also complementary to the corresponding first microstructures of the first photoresist layer 621. Therefore, the first female mold 660 had a same pattern with the light guiding pattern 621 of the first photoresist layer 611.

### Example 3

### Manufacturing a Second Female Mold

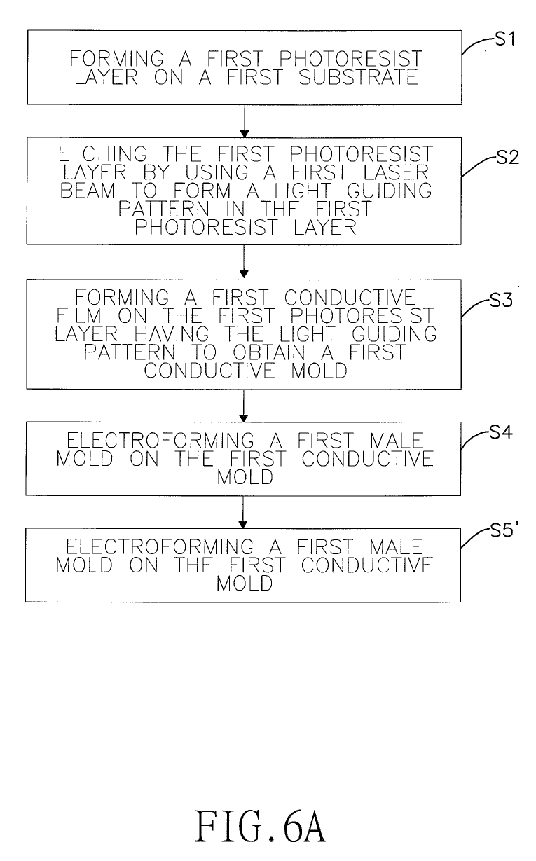

With reference to FIGS. 7A and 7B, the method for manufacturing a second female mold was implemented as described in the method of the Example 1. In the present embodiment, a second photoresist layer 711 was formed onto the second substrate 710 in the step (S 1); the second photoresist layer 711 was etched as the Example 1 and formed with a light scattering pattern 721 in the step (S2); a second conductive layer 731 was further formed on the second photoresist layer 711 with the light scattering pattern 721 so as to obtain a second conductive mold 732 in the step (S3); the second conductive mold 731 was electroformed and form a Ni—Co electroform product 740 on the second conductive mold 731, and the Ni—Co electroform product 740 separated from the second conductive mold 731 was the second male mold 750.

After that, the second male mold 750 was used as a conductive mold. The second male mold 750 was immersed in a Ni—Co alloy electroforming bath to form a second female mold 760 on the first male mold 750 in the step (S5″). Thus, a second female mold 760 with a pattern corresponding to the pattern of the second male mold 750 was obtained.

Here, the second female mold 760 has multiple tenth microstructures 761 and multiple eleventh microstructures 762 formed in the second female mold 760. Each tenth microstructure 761 was complementary to the corresponding fifth microstructure of the first male mold 750, and each eleventh microstructure 762 was complementary to the corresponding sixth microstructure of the first male mold 750. Because the fifth and sixth microstructures were respectively complementary to the second and the third microstructures of the first photoresist layer 721, the second female mold 760 had a same pattern with the light scattering pattern 721 of the second photoresist layer 711.

### Example 4

### Manufacturing a Multi-Functional Light Guide Plate

According to the method for manufacturing a multi-functional light guide plate, the first male mold or the first female mold was used as a first mold, and the second male mold or the second female mold was used as a second mold. A raw material such as PMMA was provided. Then, the raw material was molded with the first mold and the second mold by injection molding, imprint molding, or calendaring to form a multi-functional light guide mold. Depending on different surface microstructures of the first mold and the second mold, the multi-functional light guide mold had a light guiding pattern at one surface by molding with the first mold and had a light scattering pattern at the other surface by molding with the second mold. Accordingly, the multi-functional light guide plate in accordance with the present invention had both light guiding and light scattering functions.

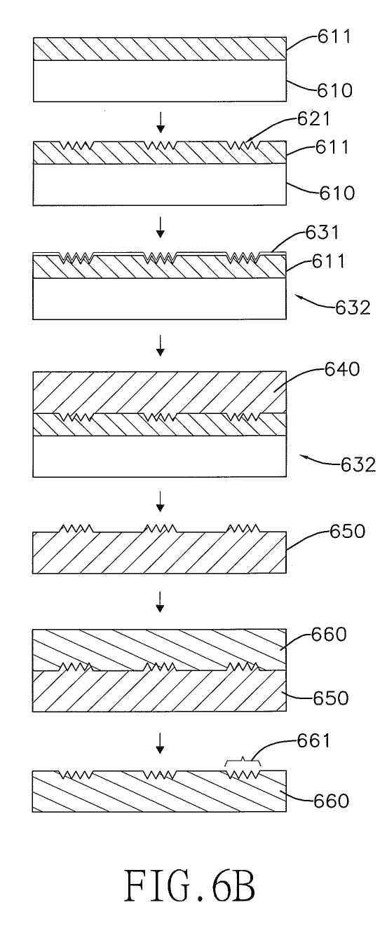

With reference to FIG. 8, the first mold was first male mold 150 and the second mold was the second female mold 760. The light guiding pattern of the first male mold 150 was faced to the light scattering pattern of the second female mold 760. After performing an injection molding with these two molds, a multi-functional light guide plate having a light guiding pattern formed in one surface and having a light scattering pattern formed on the other surface was produced.

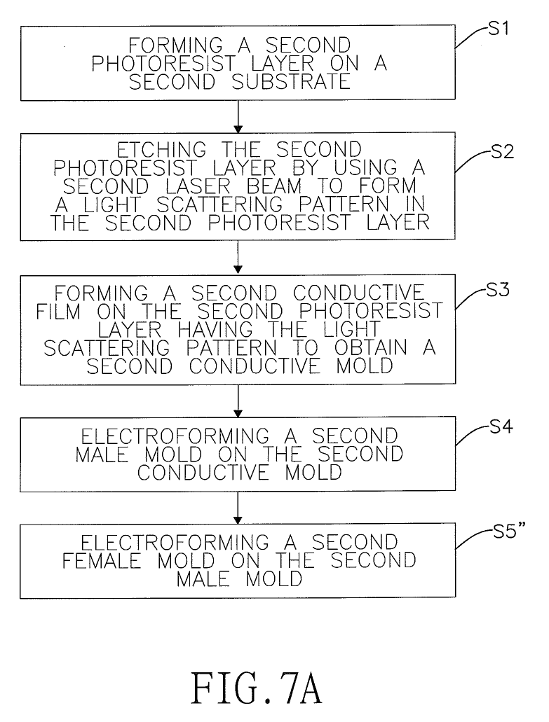

With reference to FIG. 9, the first mold was first male mold 150 and the second mold was the second male mold 250. The light guiding pattern of the first male mold 150 was faced to the light scattering pattern of the second male mold 250. After performing an injection molding with these two molds, a multi-functional light guide plate having a light guiding and a light scattering pattern respectively formed in one surface and the other surface was produced.

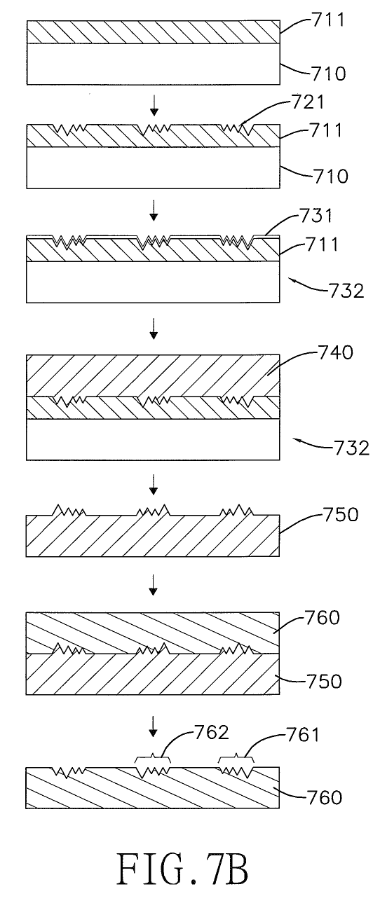

With reference to FIG. 10, the first mold was first female mold 660 and the second mold was the second male mold 250. The light guiding pattern of the first female mold 660 was faced to the light scattering pattern of the second male mold 250. After performing an injection molding with these two molds, a multi-functional light guide plate having a light guiding pattern formed on one surface and having a light scattering pattern formed in the other surface was produced.

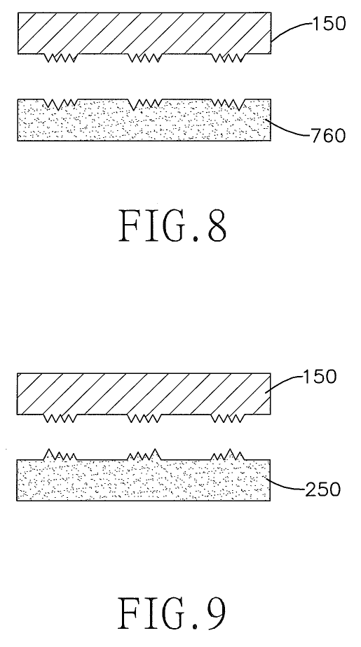

With reference to FIG. 11, the first mold was first female mold 660 and the second mold was the second female mold 760. The light guiding pattern of the first female mold 660 was faced to the light scattering pattern of the second female mold 760. After performing an injection molding with these two molds, a multi-functional light guide plate having a light guiding and a light scattering pattern respectively formed on one surface and the other surface was produced.

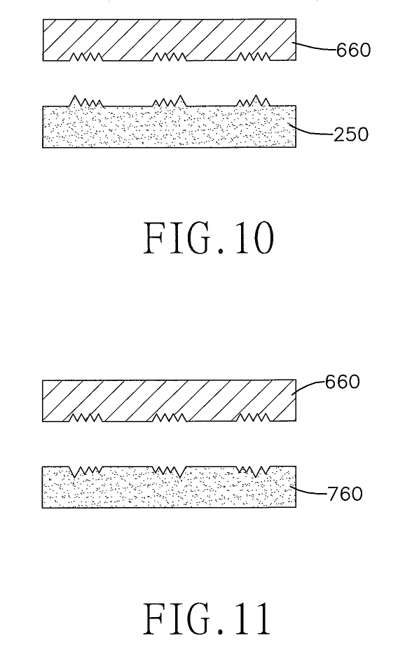

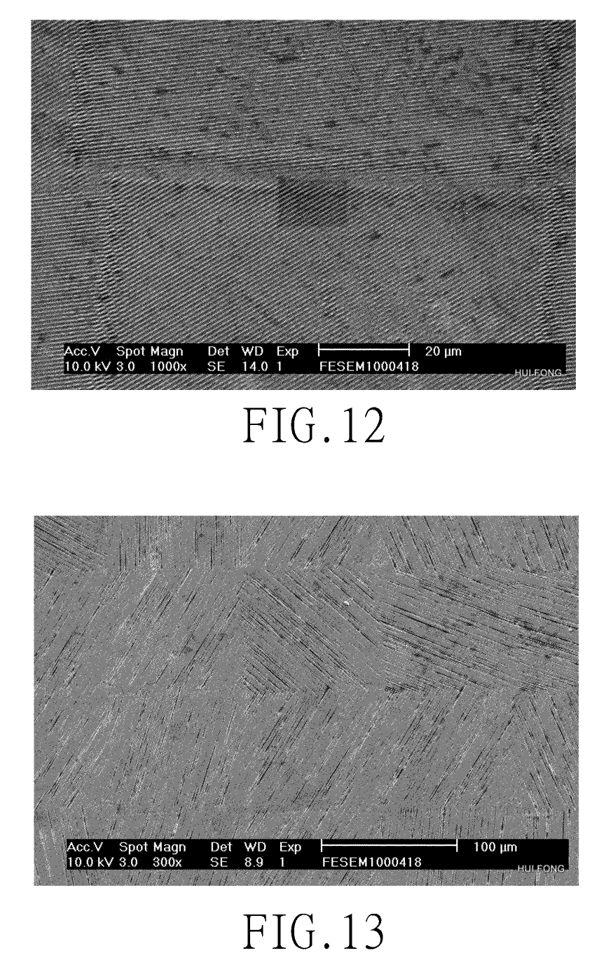

As described by the abovementioned combination examples, the surface structure of the light guiding pattern of the multi-functional light guide plate was shown in FIG. 12, which comprised multiple grooves having the same width. In addition, the surface structure of the light scattering pattern of the multi-functional light guide plate was shown in FIG. 13, which comprised multiple grooves having various widths. Here, the grooves of same microstructure were formed extending along a direction and parallel to each other. The grooves of different two microstructures were formed extending along respective directions having an angle from 15° to 90° in between.

Therefore, manufacturers can produce various multi-functional light guide plates with different surface microstructures by using the first male mold or first female mold with the second male mold or the second female mold. Furthermore, because the first microstructure and the scattering microstructure are formed on the shallow surface of the first mold and the second mold respectively, a multi-functional light guide plate can have an improved light transmittance up to 93%. In comparison with the conventional light guide plate (having a light transmittance of only 73%), a display device comprising the multi-functional light guide plate manufactured by the method in accordance with the present invention can integrate and replace multiple optical sheets such as scattering sheets, brightness-improving sheets, and/or reflective sheets, and thus improve the display devices to become more lightweight and thinner products.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A method for manufacturing a mold assembly of a multi-functional light guide plate, comprising the steps of:
(S1) forming a first photoresist layer on a first substrate and forming a second photoresist layer on a second substrate;
(S2) etching the first photoresist layer by using a first laser beam to form a light guiding pattern in the first photoresist layer and etching the second photoresist layer by using a second laser beam to form a light scattering pattern in the second photoresist layer,
wherein the light guiding pattern comprises multiple first microstructures formed in the first photoresist layer, and each first microstructure has multiple first grooves extending along a first direction and parallel to each other, and
the light scattering pattern comprises at least one second microstructure and at least one third microstructure formed in the second photoresist layer, each second microstructure has multiple second grooves extending along a second direction and parallel to each other, each third microstructure has multiple third grooves extending along a third direction and parallel to each other, and the third direction is arranged at an angle larger than 0° and smaller than 180° to the second direction;
(S3) forming a first conductive film on the first photoresist layer having the light guiding pattern to obtain a first conductive mold and forming a second conductive film on the second photoresist layer having the light scattering pattern to obtain a second conductive mold; and
(S4) electroforming a first male mold on the first conductive mold and electroforming a second male mold on the second conductive mold, so as to obtain the mold assembly comprising the first male mold and the second male mold,
wherein the first male mold has a pattern corresponding to the light guiding pattern of the first photoresist layer, the pattern comprises multiple fourth microstructures formed on the first male mold, and the fourth microstructures are complementary to the corresponding first microstructures of the light guiding pattern, and
the second male mold has a pattern corresponding to the light scattering pattern of the second photoresist layer, the pattern comprises at least one fifth microstructures and at least one sixth microstructures formed on the second male mold, the at least one fifth microstructure is complementary to the at least one corresponding second microstructure of the light scattering pattern, and the at least one sixth microstructure is complementary to the at least one corresponding third microstructure of the light scattering pattern.

2. The method as claimed in claim 1, wherein the step (S2) further comprises the steps of:
providing a focused laser beam;
shaping the focused laser beam by passing the focused laser beam through a hole;
interfering the focused laser beam with an adjustable rotating grating to obtain multiple interfered laser beams with various predetermined energies; and
focusing two interfered laser beams with a second highest energy to form the first laser beam or the second laser beam.

3. The method as claimed in claim 2, wherein the adjustable rotating grating has multiple slits spaced with a constant interval in between, and the adjustable rotating grating is fixed at a constant angle in front of the focused laser beam to form the first laser beam.

4. The method as claimed in claim 2, wherein the adjustable rotating grating has multiple slits spaced with multiple different intervals, and the adjustable rotating grating is rotated in a speed ranging from 90°/sec to 180°/sec at a fixed position in front of the focused laser beam to form the second laser beam.

5. The method as claimed in claim 2, wherein the hole has a diameter ranging from 10 micrometers to 100 micrometers and has a shape of rectangle, circle, or triangle.

6. The method as claimed in claim 1, wherein the step (S4) further comprises:
immersing the first conductive mold and the second conductive mold in a Ni—Co alloy electroforming bath to form a first Ni—Co electroform product on the first conductive mold and a second Ni—Co electroform product on the second conductive mold respectively; and
separating the first Ni—Co electroform product from the first conductive mold so as to obtain the first male mold and separating the second Ni—Co electroform product from the second conductive mold so as to obtain the second male mold.

7. The method as claimed in claim 1, wherein the first grooves of the first microstructures have the same width, the second grooves of the second microstructures have various widths, and the third grooves of the third microstructures have various widths.

8. The method as claimed in claim 7, wherein the first grooves, the second grooves, and the third grooves have widths ranging from 0.3 micrometers to 0.9 micrometers.

9. The method as claimed in claim 7, wherein the first grooves of each first microstructure have the same depth, the second grooves of the second microstructures have various depths, and the third grooves of each third microstructure have various depths.

10. The method as claimed in claim 9, wherein the first grooves, the second grooves, and the third grooves have depths ranging from 0.3 micrometers to 0.5 micrometers.

11. The method as claimed in claim 1, wherein the angle between the second direction and the third direction ranges from 15° to 90°.

12. The method as claimed in claim 1, wherein each second microstructure has multiple first sub-microstructures and multiple second sub-microstructures distributed at a region of the second microstructure and formed in the second photoresist layer, each first sub-microstructure has multiple seventh grooves extending along a seventh direction and parallel to each other, and each second sub-microstructure has multiple eighth grooves extending along an eighth direction and parallel to each other,
wherein the eighth direction is arranged at an angle ranging from 15° to 90° to the seventh direction, the seventh grooves of each first sub-microstructure have various widths and various depths, and the eighth grooves of each second sub-microstructures have various widths and various depths.

13. The method as claimed in claim 1, wherein the fourth grooves, the fifth grooves, and the sixth grooves have widths ranging from 0.3 micrometers to 0.9 micrometers and depths ranging from 0.2 micrometers to 0.5 micrometers.

14. The method as claimed in claim 1, wherein the method further comprises a step (S5′) after the step (S4): electroforming a first female mold on the first male mold, and the first female mold has a pattern corresponding to the pattern of the first male mold, the pattern of the first female mold comprises multiple ninth microstructures formed in the first female mold, and the ninth microstructures are complementary to the corresponding fourth microstructures.

15. The method as claimed in claim 1, wherein the method further comprises a step (S5″) after the step (S4): electroforming a second female mold on the second male mold, and the second female mold has a pattern corresponding to the pattern of the second male mold, the pattern of the second female mold comprises at least one tenth microstructure and at least one eleventh microstructure formed in the second female mold, wherein the at least one tenth microstructure is complementary to the at least one corresponding fifth microstructure and the at least one eleventh microstructure is complementary to the at least one corresponding sixth microstructure of the first male mold.

16. The method as claimed in claim 14, wherein the method further comprises a step (S5″) after the step (S4): electroforming a second female mold on the second male mold, and the second female mold has a pattern corresponding to the pattern of the second male mold, the pattern of the second female mold comprises at least one tenth microstructure and at least one eleventh microstructure formed in the second female mold, wherein the at least one tenth microstructure is complementary to the at least one corresponding fifth microstructure and the at least one eleventh microstructure is complementary to the at least one corresponding sixth microstructure of the first male mold.

17. A method for manufacturing a multi-functional light guide plate, comprising the steps of:
providing a first male mold and a second male mold manufactured by the method as claimed in claim 1;
providing a raw material; and
molding the raw material by using the first male mold and the second male mold by injection molding, imprint molding, or calendaring to obtain the multi-functional light guide plate;
wherein the multi-functional light guide plate has a light guiding pattern formed in a surface of the multi-functional light guide plate and a light scattering pattern formed in the opposite surface of the multi-functional light guide plate, and the multi-functional light guide plate has a light transmittance ranging from 88% to 93%.

18. A method for manufacturing a multi-functional light guide plate, comprising the steps of:
providing a first male mold and a second female mold manufactured by the method as claimed in claim 15;
providing a raw material; and
molding the raw material by using the first male mold and the second female mold by injection molding, imprint molding, or calendaring to obtain the multi-functional light guide plate;
wherein the multi-functional light guide plate has a light guiding pattern formed in a surface of the multi-functional light guide plate and a light scattering pattern formed in the opposite surface of the multi-functional light guide plate, and the multi-functional light guide plate has a light transmittance ranging from 88% to 93%.

19. A method for manufacturing a multi-functional light guide plate, comprising the steps of:
providing a first female mold and a second male mold manufactured by the method as claimed in claim 14;
providing a raw material; and
molding the raw material by using the first female mold and the second male mold by injection molding, imprint molding, or calendaring to obtain the multi-functional light guide plate;
wherein the multi-functional light guide plate has a light guiding pattern formed in a surface of the multi-functional light guide plate and a light scattering pattern formed in the opposite surface of the multi-functional light guide plate, and the multi-functional light guide plate has a light transmittance ranging from 88% to 93%.

20. A method for manufacturing a multi-functional light guide plate, comprising the steps of:
providing a first female mold and a second female mold manufactured by the method as claimed in claim 16;
providing a raw material; and
molding the raw material by using the first female mold and the second female mold by injection molding, imprint molding, or calendaring to obtain the multi-functional light guide plate;
wherein the multi-functional light guide plate has a light guiding pattern formed in a surface of the multi-functional light guide plate and a light scattering pattern formed in the opposite surface of the multi-functional light guide plate, and the multi-functional light guide plate has a light transmittance ranging from 88% to 93%.
